(19) United States
(12) Patent Application Publication
(10) Pub. No.: US 2015/0327035 A1
(43) Pub. Date: Nov. 12, 2015

(54) FAR-END CONTEXT DEPENDENT PRE-PROCESSING

(71) Applicant: Intel Corporation, Santa Clara, CA (US)

(72) Inventors: Swarnendu Kar, Hillsboro, OR (US); Saurabh Dadu, Tigard, OR (US)

(21) Appl. No.: 14/275,631

(22) Filed: May 12, 2014

(51) Int. Cl. H04W 4/16; G10L 21/0208; G10L 21/02; H04M 9/08; H04M 9/10

(52) U.S. Cl. CPC H04W 4/16; H04M 9/085; H04M 9/10; G10L 21/0205; G10L 21/0208; H04W 88/06

(57) ABSTRACT

This application discusses among other things apparatus and methods for optimizing speech recognition at a far-end device. In an example, a method can include establishing a link with a far-end communication device using a near-end communication device, identifying a context of the far end communication device, and selecting one audio processing mode of a plurality of audio processing modes at the near-end communication device, the one audio processing mode associated with the identified context of the far-end device, and configured to reduce reception error by the far-end communication device of audio transmitted from the near-end communication device.

### TECHNICAL FIELD

Embodiments described herein generally relate to communication devices and in particular, to systems and methods to select and provide far-end context dependent pre-processing.

### BACKGROUND

A goal of most communication systems is to provide the best and most accurate representation of a communication from the source of the information to the recipient. Although automated telephone systems and mobile communications have allowed more instant access to information and people, there remain occasions where such technology has provided such very poor performance that some people feel very uncomfortable that the communication system is providing an accurate representation of the information intended to be communicated or requested to receive.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally a flowchart of an example method of determining a far-end context and modifying near-end processing to minimize reception errors at the far-end context, according to an embodiment;

FIG. 2 illustrates generally a flowchart of an example method of determining or identifying a far-end context and selecting a preprocessing function associated with the identified far-end context, according to an embodiment;

FIG. 3 illustrates generally a flowchart of an example method of determining or identifying a far-end context and selecting a preprocessing function associated with the identified far-end context, according to an embodiment;

FIG. 4A illustrates generally a flowchart of an example method of determining or identifying a far-end context and selecting a preprocessing function associated with the identified far-end context, according to an embodiment;

FIG. 4B illustrates generally a flowchart of an example method of a first communication device for selecting a preprocessing mode associated with an identified context of a second communication device, where the first communication device that receives a call from the second communication device, or receives a call from the second communication device and the first communication device experiences a change in context, according to an embodiment;

FIG. 4C illustrates generally a flowchart of an example method for placing a call, providing context information, receiving context information for a far-end device and selecting a preprocessing function or mode associated with the context information for the far-end context, according to an embodiment;

FIG. 5 illustrates generally an example noise reduction mechanism for pre-processing near-end audio information for a far-end human context, according to an embodiment;

FIG. 6 illustrates generally an example noise reduction mechanism for pre-processing near-end audio information for a far-end machine context, according to an embodiment; and

FIG. 7 is a block diagram illustrating an example machine, or communication device upon which any one or more of the methodologies herein discussed may be run, according to an embodiment.

### DETAILED DESCRIPTION

A goal of most communication systems is to provide the best and most accurate representation of a communication from the source of the information to the recipient. Although automated telephone systems and mobile communications have allowed more instant access to information and people, there remain occasions where such technology has provided such very poor performance that some people feel very uncomfortable that the communication system is providing an accurate representation of the information intended to be communicated or requested to receive. The present inventors have recognized that once a context of a far-end communication device is known, a near-end device can select and process communication signals to accommodate more efficient transfer of the signals and to improve the probability that the far-end context can accurately interpret received information.

In general, retail telephones available today, including mobile phones, can include multiple microphones. One or more of the microphones can be used to capture and refine audio quality which is one of the primary functions of a telephone. During a particular communication session, a phone user can communicate with one or more far-end contexts. Two predominate far-end contexts include another person and a machine, such as an automated assistant. The present inventors have recognized that today's phones can be used to refine the audio quality effectively for both the aforementioned far-end contexts. Since the audio perception mechanism for human is different from that of machines, the optimal speech refinement principle/mechanism is different for each of the far-end contexts. Presently, communication devices designed to transmit audio information process the audio information, such as the audio information received on more than one microphone, for human reception only. The present inventors have recognized that processing audio information at a near end device for reception by a human ear at the far-end device can result in a sub-optimal user experience especially in situations where the far-end context includes a machine instead of a human.

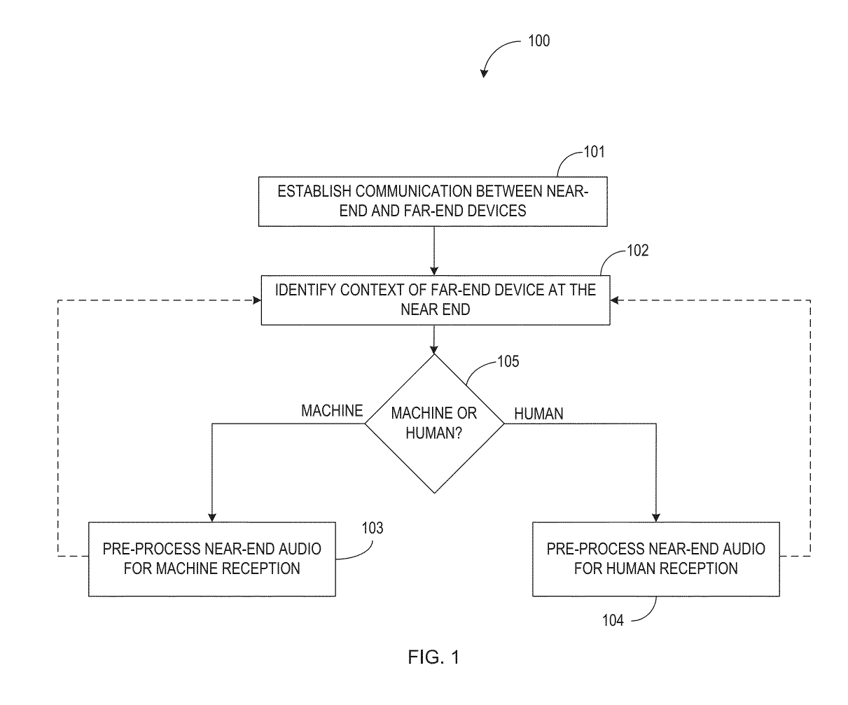

FIG. 1 illustrates generally a flowchart of an example method 100 of determining a far-end context and modifying near-end processing to minimize reception errors at the far-end context. At 101, communication between a near-end device and a far-end device is established. At 102, the context of the far-end device is determined or identified at the near-end. At 103, if the far-end context is identified as a machine at 105, audio information is pre-processed for reception by the far-end machine. At 104, if the far-end context is identified as human at 105, audio information is pre-processed for reception by the human at the far-end device. In certain situations, such as an automated call center, a user at a near-end device may communicate to a combination of far-end contexts including machines and other people. In such situations, either the user or the near-end device can optionally continue to monitor the context of the far-end and adjust pre-processing of the near-end device to match the identified far-end context.

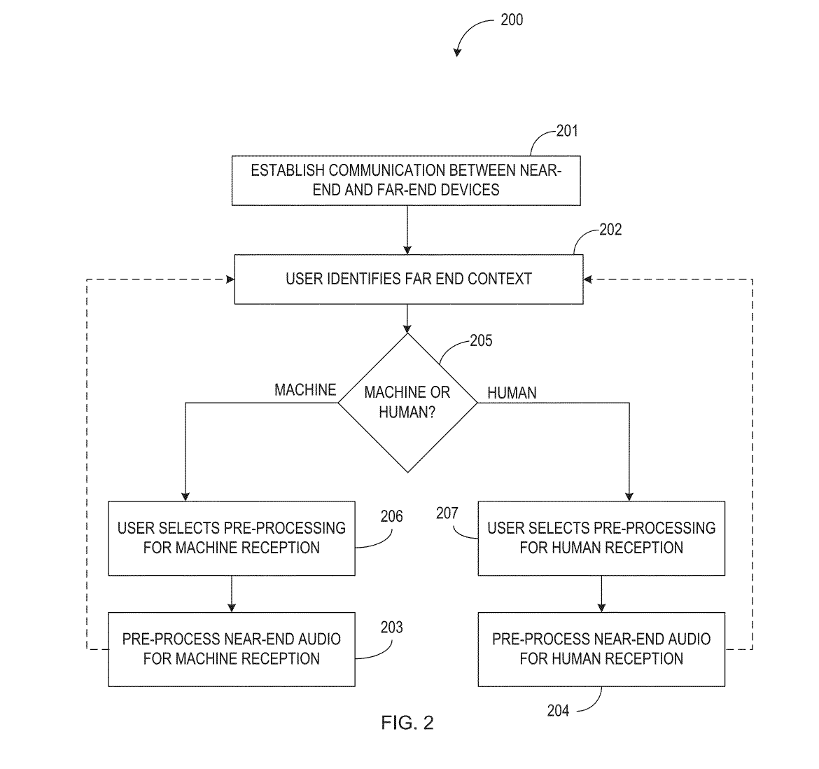

FIG. 2 illustrates generally a flowchart of an example method 200 of determining or identifying a far-end context and selecting a preprocessing function associated with the identified far-end context. At 201, communication between a user at near-end device and a far-end device can be established. At 202, the user can listen to the audio received from the far-end context and can identify if the far end-context is a machine or another person. At 206, if the far-end context is identified as a machine at 205, the user can use an input device, such as a switch or a selector, of the near-end device to select a preprocessing method associated with machine reception. At 207, if the far-end context is identified as a human at 205, the user can use an input device of the near-end device to select a preprocessing method associated with human reception. At 203, near-end audio information can be pre-processed for reception by the far-end machine. At 204, near-end audio information can be pre-processed for reception by the human at the far-end device. In certain examples, the user can continue to monitor the audio from the far-end device and if the context changes, for example from a machine to a human, or vice versa, the user at the near-end device can use the input device of the near-end device to change the preprocessing method.

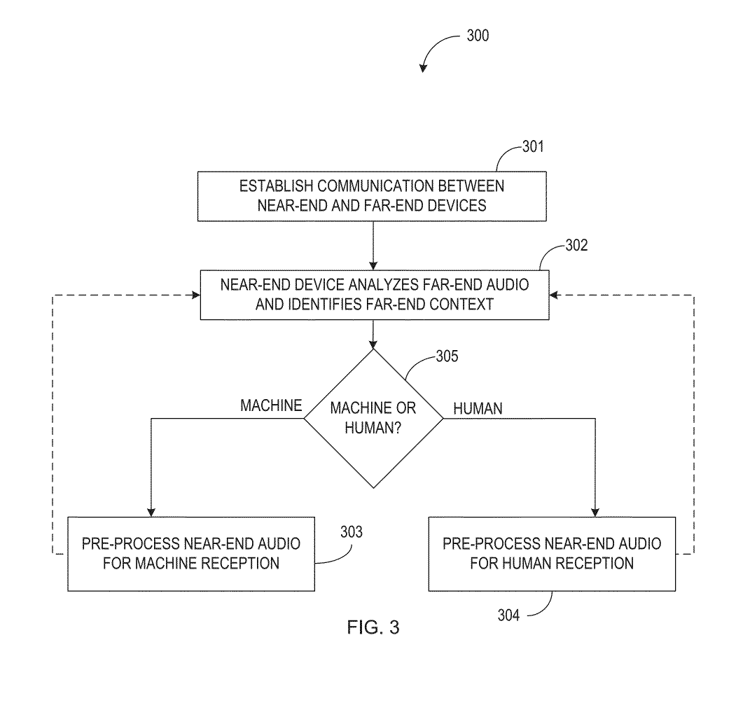

FIG. 3 illustrates generally a flowchart of an example method 300 of determining or identifying a far-end context and selecting a preprocessing function associated with the identified far-end context. At 301, communication between a user at near-end device and a far-end device can be established. At 302, the near end device can receive audio from the far-end device, analyze the audio and identify a context of the far-end device. At 303, if the far-end context is identified as a machine at 305, near-end audio information can be pre-processed for reception by the far-end machine. At 304, if the far-end context is identified as human at 305, near-end audio information can be pre-processed for reception by the human at the far-end device. In certain situations, such as an automated call center, a user at a near-end device may communicate to a combination of far-end contexts including machines and other people. In such situations, the near-end device can optionally continue to monitor the context of the far-end and adjust pre-processing of the near-end device to match the identified far-end context.

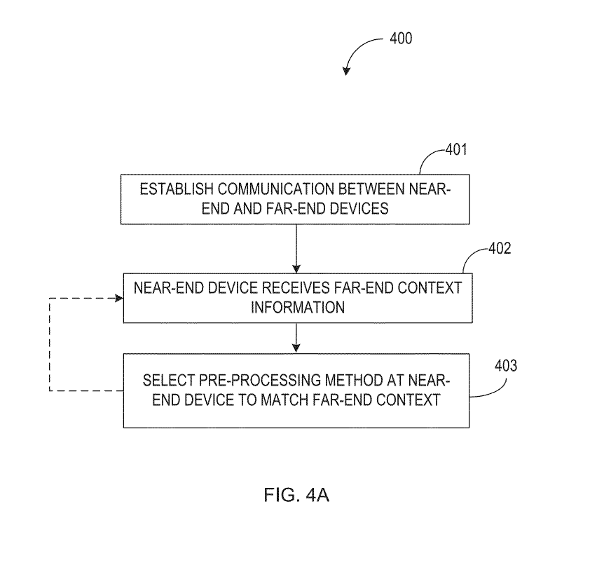

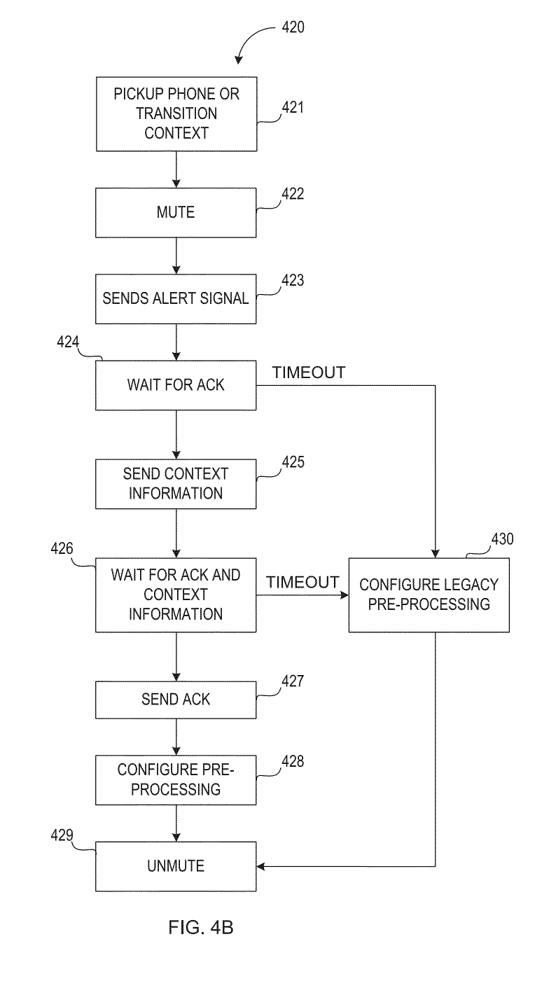

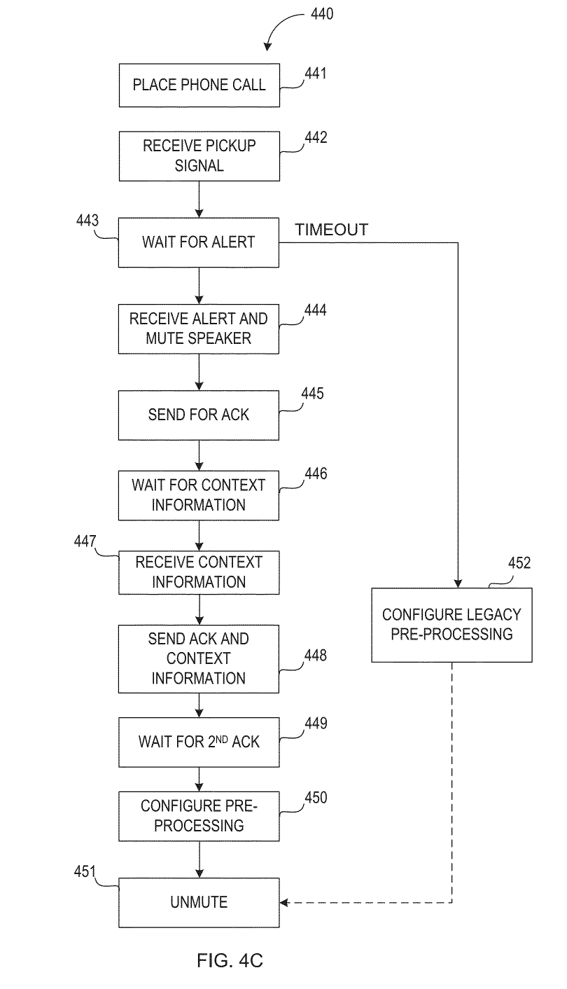

FIG. 4A illustrates generally a flowchart of an example method 400 of determining or identifying a far-end context and selecting a preprocessing function associated with the identified far-end context, according to an embodiment. At 401, communication between a near-end device and a far-end device can be established. In certain examples, the establishment of communication can include a caller at either end calling the communication device at the other end. In certain examples, establishing communications can include the call being accepted at the other end. At 402, the near-end device can receive context information transmitted by the far-end device. At 403, the near-end device can automatically select a preprocessing method that matches the context information received from the far-end device. In certain situations, such as an automated call center, a user at a near-end device may communicate to a combination of far-end contexts including machines and other people. In such situations, the near-end device can optionally continue to monitor the context of the far-end and adjust pre-processing of the near-end device to match the identified far-end context.

In certain examples, the far-end device can use an audible or in-band tone to send the context information to the near end device. The near-end device can receive the tone and demodulate the context information. In some examples, the near-end device can mute the in-band tone from being broadcast to the user. In some examples, the far-end device can use one or more out-of-band frequencies to send the context information to the near end device. In such examples, the near-end device can monitor one or more out-of-band frequencies for far-end context information and can select an appropriate pre-processing method for the identified far-end context.

In certain examples, a near-end device can include at least two pre-processing modes. In certain examples, a first pre-processing mode can be configured to provide clear audio speech for reception by a human, such as a human using a far-end device and listening to the voice of a near-end device user. In certain examples, a second pre-processing mode can be configured to provide clear audio speech for reception by a machine, such as an automated attendant employed as the far-end device and listening to the voice of a near-end device user.

Since a human ear perceives noisy signals differently compared to machines, different noise reduction mechanisms can be used for human and non-human listeners to enhance the probability that noise information received by each is correctly perceived by each. Human listening can discern even a small amount of distortion resulting due to traditional noise reduction methods (e.g., musical noise arising out of intermittent zeroing out of noisy frequency bands). In general, musical noise, for example, does not affect speech recognition by machines. In certain examples, audio codecs for encoding speech can employ algorithms that achieve better compression efficiency depending on whether the speech is targeted for human or machine ears.

FIG. 4B illustrates generally a detailed flowchart of an example method 420 of a first communication device for selecting a preprocessing mode associated with an identified context of a second communication device, where the first communication device that receives a call from the second communication device, or receives a call from the second communication device and the first communication device experiences a change in context, according to an embodiment. At 421, the method can include receiving a phone call from a second communication device, or receiving an indication that the context of the first communication device has changed. At 422, the method can include muting the speaker of the first communication device. At 423, the method can include sending an alert signal to notify the second communication device that the first communication device includes the capability to identify the context of the first communication device. In certain examples, an alert signal can be exchanged between devices using a dual tone format. At 424, the method can include waiting for a first acknowledgement (ACK) from the second communication device. At 425, upon receiving the first acknowledgment, the method can include sending context information about the first communication device. In certain examples, context information can be exchanged between the devices using frequency shift keying (FSK). At 426, the method can include waiting for a second acknowledgement and a context of the second communication device. At 427, after receiving the second acknowledgement and the context of the second communication device from the second communication device, the method can include sending a third acknowledgement to the second communication device. In certain examples, an acknowledgement can be exchanged between devices using a dual tone format. At 428, the first communication device can be configured to pre-process audio information according the context information received from the second communication device. At 429, the speaker of the first communication device can be unmuted. In certain examples, at 430, when the first communication devices times out waiting for the first acknowledgement, the first communication device can select a default preprocessing mode, such as a legacy preprocessing mode, for preprocessing audio information for transmission to the second communication device.

FIG. 4C illustrates generally a detailed flowchart of an example method 440 for placing a call, providing context information, receiving context information for a far-end device and selecting a preprocessing function or mode associated with the context information for the far-end context, according to an embodiment. At 441, the method can include placing a phone call to a second communication device. At 442, the method can include receiving a pick-up signal indicating the second communication device received and accepted the phone call. At 443, the method can include waiting for an alert signal. At 444, the method can include muting the speaker of the first communication device upon receiving the alert signal. At 445, the method can include sending an acknowledgement (ACK) to notify the second device that the first device received the alert signal. In certain examples, an acknowledgement can be exchanged between devices using a dual tone format. At 446, the method can include waiting for context information from the second device and at 447, receiving the context information. In certain examples, context information can be exchanged between the devices using frequency shift keying (FSK). At 448, upon receiving the context information for the second communication device, the method can include sending an acknowledgement and context information about the first communication device. At 449, the method can include waiting for a second acknowledgement from the second communication device and receiving the second acknowledgement. At 450, after receiving the second acknowledgement from the second communication device, the method can include configuring the first communication device to pre-process audio information according the context information received from the second communication device. At 451, the speaker of the first communication device can be unmuted. In certain examples, at 452, when the first communication devices times out waiting for the alert, the first communication device can select a default preprocessing mode, such as a legacy preprocessing mode, for preprocessing audio information for transmission to the second communication device. In certain examples, after selecting a default preprocessing mode, the first communication device can optionally unmute the speaker to be sure the user can receive audio communications.

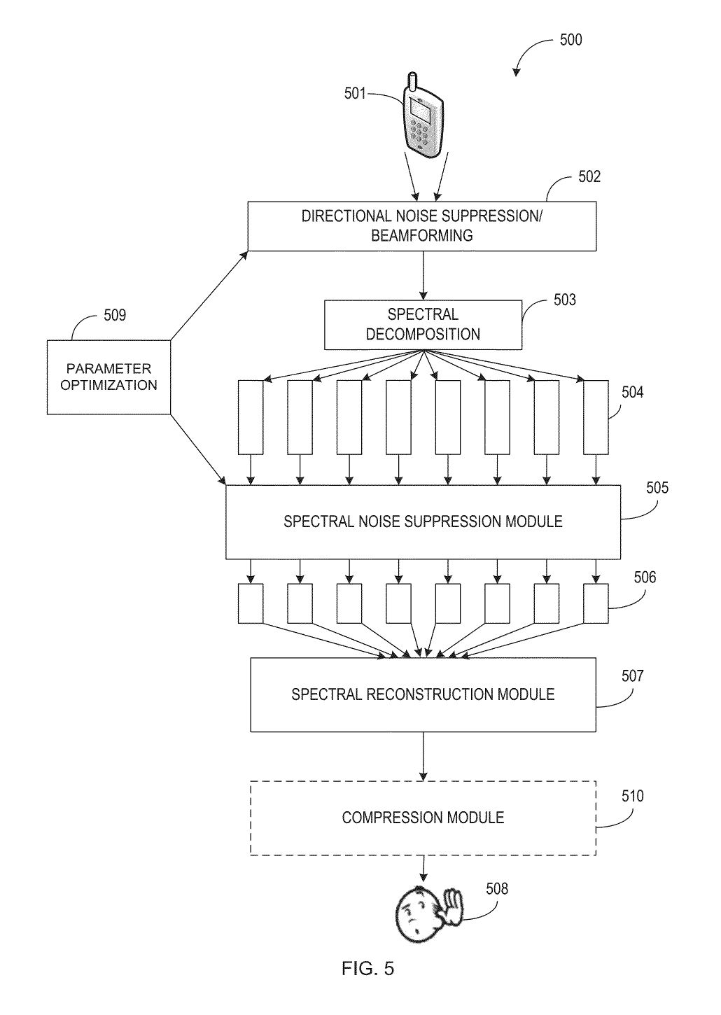

FIG. 5 illustrates generally an example noise reduction mechanism 500 for pre-processing near-end audio information for a far-end human context 508. In certain examples, a first pre-processing mode can analyze input from multiple microphones of the near-end device 501 and can process the combined audio signal to remove noise and to compress the transmitted signal so as to conserve transmission bandwidth. At 502, one or more processors of the near-end device can receive audio signals from one or more microphones of the near-end device 501, analyze the audio information, reduce directional noise, and perform beamforming to enhance the environmental context of the audio information. In certain examples, a spectral decomposition module 503 can separate the beamformed audio signals or audio information into several spectral components 504. A spectral noise suppression module 505 at the near-end device can analyze the spectral components 504 and can reduce noise based on processing parameters 509 optimized for reception of the audio information by a human being. Such noise reduction can include suppressing energy levels of frequencies that include high sustained energy. Such high-energy frequency bands can indicate sounds that can interfere with ability of a human to hear speech information at nearby frequencies. As an example, if the near-end user is in an area that includes a fan such as a ceiling fan, heater fan, air conditioner fan, computer fan, etc., the fan can produce auditory noise at one or more frequency bands associated with for example the rotating speed of the fan. The one or more processors of the near-end device can analyze frequency bands and can identify bands within the speech frequencies where sustained energies are not typically found in speech and can suppress the energy of those frequency bands, thus, reducing the interference of the fan noise with respect to the speech information. In certain examples, the spectral noise suppression module 505 can provide a processed and noise-reduced audio spectrum 506. A spectral reconstruction module 507 can reconstruct the processed and noise-reduced audio spectrum 506 for transmission to a far-end device and a far-end human context 508. In certain examples, such as digital transmission systems, the processed and noise-reduced audio information can be compressed to conserve transmission bandwidth and processing at the far-end device. In certain examples, the compression module 510 can use information from the previous processing at the near-end device to enhance the compression method or to maximize the compression ratio. As discussed above, parameters for one or more modules of the noise reduction mechanism 500 can be optimized (block 509). In some examples, the parameters can be optimized using mean opinion scores from human listening tests.

With machines, an end-criteria can be to maximize speech recognition accuracy, and/or reduce the word error rate, while with human audition, end-criteria can be a mixture of both intelligibility and overall listening experience that can often be standardized through metrics like perceptual evaluation of speech quality (PEQS) and mean opinion score (MOS). Machine recognition can be performed on a limited number of speech features, or feature bands, extracted from a received audio signal or received audio information. Speech features can be different from simple spectrograms and a noisy environment, or feature noise, can impact speech features computed in a non-linear manner. Sophisticated noise reduction techniques, such as neural network techniques, can be used directly in the feature domain for feature noise and machine reception noise reduction.

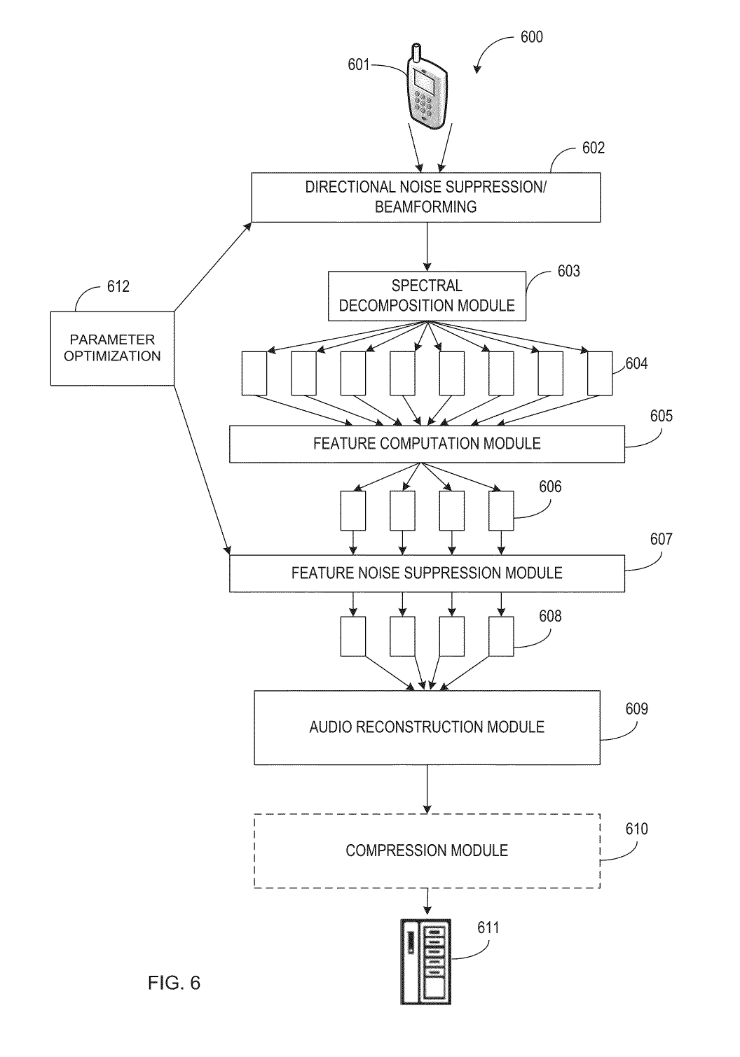

FIG. 6 illustrates generally an example noise reduction mechanism 600 for pre-processing near-end audio information for a far-end machine context. In an example, one or more processors of the near-end device 601 can receive audio signals from one or more microphones of the near-end device. The one or more processors can analyze the audio information, reduce directional noise and perform beamforming to enhance the environmental context of the audio information (block 602). A spectral decomposition module 603 can separate the beamformed audio signals or audio information into several spectral components 604. A feature computation module 605 can compute and/or identify speech features and the spectral components can be reduced to one or more speech feature components 606. A feature noise suppression module 607 can analyze the speech feature components 606 for feature noise and the feature noise can be suppressed to provide noise-suppressed feature components 608. An audio reconstruction module 609 can reconstruct a processed audio spectrum and signal using the noise-suppressed feature components 608. In certain examples, a compression module 610 can compress the reconstructed audio signal to reduce bandwidth and processing burdens, and the compressed audio information can then be transmitted using a wired communication network, a wireless communication network or a combination of wired and wireless communication resources to a machine context 611 such as a speech recognition server. In certain examples, parameters for one or more modules of the noise reduction mechanism 600 can be optimized 612. In some examples, the parameters can be optimized based on word error rates of large pre-recorded training datasets.

Based on whether the listener is a human or a machine, different speech codecs can be employed to enable better compression efficiency. For example, the ETSI ES 2020 50 standard specifies a codec that can enable machine-understandable speech compression at only 5 Kbits/sc while resulting in satisfactory speech recognition performance. By contrast, the ITU-TG.722.2 standard, which can ensure high speech quality for human listeners, uses a data rate of 16 Kbits/sec.

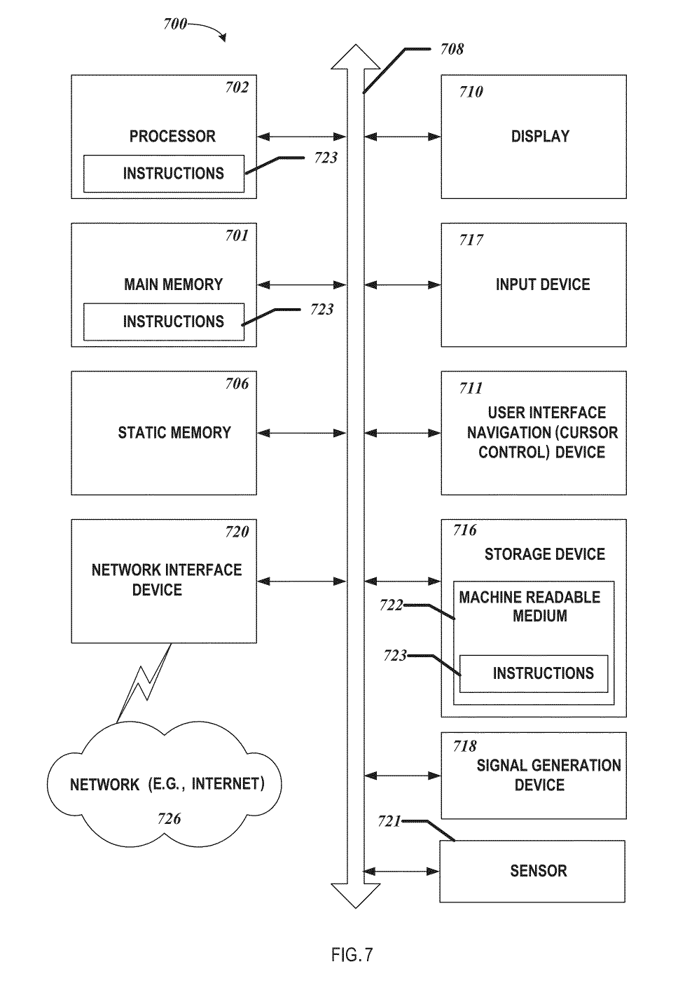

FIG. 7 is a block diagram illustrating an example machine, or communication device upon which any one or more of the methodologies herein discussed may be run. In alternative embodiments, the communication device can operate as a standalone device or may be connected (e.g., networked) to other machines. In a networked deployment, such as a telephone network, the communication device may operate in the capacity of either a server or a client communication device in server-client network environments, or it may act as a peer communication device in peer-to-peer (or distributed) network environments. The communication device may be a personal computer (PC), a tablet PC, a set-top box (STB), a Personal Digital Assistant (PDA), a mobile telephone, a web appliance, a network router, switch or bridge, or any communication device capable of executing instructions (sequential or otherwise) that specify actions to be taken by that machine. Further, while only a single communication device is illustrated, the term “communication device” can also be taken to include any collection of communication device that individually or jointly execute a set (or multiple sets) of instructions to perform any one or more of the methodologies discussed herein.

Example communication device 700 includes a processor 702 (e.g., a central processing unit (CPU)), a graphics processing unit (GPU) or both), a main memory 701 and a static memory 706, which communicate with each other via a bus 708. The communication device 700 may further include a display unit 710, an alphanumeric input device 717 (e.g., a keyboard), and a user interface (UI) navigation device 711 (e.g., a mouse). In one embodiment, the display, input device and cursor control device are a touch screen display. In certain examples, the communication device 700 may additionally include a storage device (e.g., drive unit) 716, a signal generation device 718 (e.g., a speaker), a network interface device 720, and one or more sensors 721, such as a global positioning system sensor, compass, accelerometer, or other sensor. In certain examples, the processor 702 can include a context identification circuit. In some embodiments the context identification circuit can be separate from the processor 701. In certain examples, the context identification circuit can select an audio processing mode corresponding to an identified far-end context. In some examples, the context identification circuit can identify a context using audio information received from a far-end device or audio information received from the processor 701. In some examples, the context identification circuit can analyze audio information received from a far-end device to identify a context of the far-end. In some examples, the context identification circuit can receive in-band data or out-of-band data including indicia of the far-end context.

The storage device 716 includes a machine-readable medium 722 on which is stored one or more sets of data structures and instructions 723 (e.g., software) embodying or utilized by any one or more of the methodologies or functions described herein. The instructions 723 may also reside, completely or at least partially, within the main memory 701 and/or within the processor 702 during execution thereof by the communication device 700, the main memory 701 and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 723. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Electrically Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 723 may further be transmitted or received over a communications network 726 using a transmission medium via the network interface device 720 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

In certain examples, the processor 702 can include one or more processors or processor circuits including a processing circuit configured to determine a far-end context and select a corresponding noise reduction method to ensure successful communications with the far-end context. In certain examples, the processor 702 can include one or more processors or processor circuits including a processing circuit configured provide context information using an in-band tone or one or more out-of-band frequencies.

### ADDITIONAL NOTES AND EXAMPLES

In Example 1, a method for processing near- audio received at a near-end device for optimized reception by far-end device can include establishing a link with a far-end communication device using a near-end communication device, identifying a context of the far-end communication device, and selecting one audio processing mode of a plurality of audio processing modes at the near-end communication device, the one audio processing mode associated with the identified far-end context and configured to reduce reception error by the far-end communication device.

In Example 2, the identifying the context of the far-end device of Example 1 optionally includes processing audio signals received from the far-end communication device.

In Example 3, the selecting one audio processing mode of any one or more of Examples 1-2 optionally includes presenting an input mechanism for selecting the one audio processing mode at the near-end communication device, and receiving an indication from the input mechanism associated with the one audio processing mode at a processor of the near-end communication device.

In Example 4, the identifying the context of any one or more of Examples 1-3 optionally includes receiving an in-audio-band data tone at the near-end communication device, wherein the in-audio-band data tone includes identification information for the far-end context.

In Example 5, the identifying the context of any one or more of Examples 1-4 optionally includes receiving an out-of-audio-band data signal at the near-end communication device, wherein the out-of-audio-band data signal is configured to identify the context of the far-end communication device.

In Example 6, the establishing link with the far-end communication device of any one or more of Examples 1-5 optionally includes establishing link with the far-end communication device over a wireless network using a near-end communication device.

In Example 7, the identifying a context of any one or more of Examples 1-6 optionally includes identifying a human context, and the method of any one or more of Examples 1-6 optionally includes suppressing noise in one or more frequency bands of near-end generated audio information to provide noise suppressed audio information.

In Example 8, the method of any one or more of Examples 1-7 optionally include compressing the noise suppressed audio information for transmission to the far-end communication device.

In Example 9, the identifying a context of any one or more of Examples 1-8 optionally includes identifying a machine context, and the method of any one or more of Examples 1-8 optionally includes suppressing feature noise in one or more feature bands of near-end generated audio information to provide feature-noise suppressed audio information.

In Example 10, the method of any one or more of Examples 1-9 optionally includes compressing the feature-noise suppressed audio information for transmission to the far-end context.

In Example 11, an apparatus for audio communications with a far-end communication device can include a microphone, a processor configured to receive audio information from the microphone, to process the audio information according to one of a plurality of audio processing modes, and to provide processed audio information for communication to the far-end communication device, and a context identification circuit to select an audio processing mode corresponding to an identified context of the far-end communication device from the plurality of audio processing modes of the audio processor.

In Example 12, the context identification circuit of Example 11 optionally includes a selector configured to receive a manual input from a near-end user to select the audio processing mode corresponding to an identified context of the far-end communication device.

In Example 13, the context identification circuit of any one or more of Examples 11-12 optionally is configured to receive communication information corresponding to a signal received from the far-end communication device, and to identify a context of the far-end communication device.

In Example 14, the communication information of any one or more of Examples 11-13 optionally includes far-end sourced voice information, and the context identification circuit of any one or more of Examples 1-13 optionally is configured to analyze the far-end sourced voice information to provide analysis information, and to identify a far-end context of the far-end communication device using the analysis information.

In Example 15, the communication information of any one or more of Examples 11-14 optionally includes in-audio-band data information, and the context identification circuit of any one or more of Examples 1-14 optionally is configured identify the context of the far-end communication device using the in-audio-band data information.

In Example 16, the communication information of any one or more of Examples 11-15 optionally includes out-of-audio-band data information, and the context identification circuit of any one or more of Examples 1-15 optionally is configured to identify the context of the far-end communication device using the out-of-audio-band data information.

In Example 17, the apparatus of any one or more of Examples 11-16 optionally includes a wireless transmitter configured to transmit the processed audio information to the far-end communication device using a wireless network.

In Example 18, the processor of any one or more of Examples 11-17 optionally is configured to suppress noise of one or more frequency bands of the audio information to provide the processed audio information when the far-end context is identified as a human context.

In Example 19, the processor of any one or more of Examples 11-18 optionally is configured to compress the processed audio information for transmission the far-end communication device.

In Example 20, the processor of any one or more of Examples 11-19 optionally is configured to suppress feature noise of one or more feature bands of the audio information to provide the processed audio information when the far-end context is identified as a machine context.

In Example 21, the processor of any one or more of Examples 11-20 optionally is configured to compress the processed audio information for transmission to the far-end communication device.

In Example 22, an apparatus for audio communications with a far-end communication device can include a processor configured to receive an incoming communication request, to accept the incoming communication request and to initiate transmission of an indication specifically identifying a context of the apparatus, and a transmitter configured to transmit the indication specifically identifying the context of the apparatus.

In Example 23, the transmitter of Example 22 optionally is configured to transmit the indication specifically identifying the context of the apparatus using in-audio-band frequencies.

In Example 24, the transmitter of any one or more of Examples 22-23 optionally is configured to transmit the indication specifically identifying the context of the apparatus using out-of-audio-band frequencies.

In Example 25, the transmitter of any one or more of Examples 22-24 optionally includes a wireless transmitter.

In Example 26, a method for providing context information of a communication device can include receiving an incoming communication request at the communication device, providing an indication specifically identifying the context of the apparatus, and transmitting the indication in response to the communication request using a transmitter of the communication device.

In Example 27, the transmitting the indication of Example 26 optionally includes transmitting the indication using in-audio-band frequencies.

In Example 28, the transmitting the indication of any one or more of Examples 26-27 optionally includes transmitting the indication using out-of-audio-band frequencies.

In Example 29, the transmitting the indication of any one or more of Examples 26-28 optionally includes wirelessly transmitting the indication using out-of-audio-band frequencies.

In Example 30, a machine-readable medium including instructions for optimizing reception by a far-end communication device, which when executed by a machine, cause the machine to establish a link with a far-end communication device using a near-end communication device, identify a far-end context of the far-end communication device, and select one audio processing mode of a plurality of audio processing modes at the near-end communication device, the one audio processing mode associated with the identified far-end context and configured to process audio received at the near-end for reduced reception error by the far-communication device.

In Example 31, the machine-readable medium of Example 30 includes instructions for optimizing reception by a far-end communication device, which when executed by a machine, optionally cause the machine to process audio signals received from the far-end communication device.

In Example 32, the machine-readable medium of any one or more of Examples 30-31, including instructions for optimizing reception by a far-end communication device, which when executed by a machine, optionally cause the machine to receive an indication from an input mechanism associated with the one audio processing mode at a processor of the near end communication device.

In Example 33, the machine-readable medium of any one or more of Examples 30-32, including instructions for optimizing reception by a far-end communication device, which when executed by a machine, optionally cause the machine to receive an in-audio-band data tone at the near end communication device, wherein the in-audio-band data tone includes identification information for the far-end context.

In Example 34, the machine-readable medium of any one or more of Examples 30-33, including instructions for optimizing reception by a far-end communication device, which when executed by a machine, optionally cause the machine to receive an out-of-audio-band data signal at the near-end communication device, wherein the out-of-audio-band data signal is configured to identify the context of the far-end communication device.

In Example 35, the machine-readable medium of any one or more of Examples 30-34, including instructions for optimizing reception by a far-end communication device, which when executed by a machine, optionally cause the machine to identify a human context, and suppress noise in one or more frequency bands of near-end generated audio information to provide noise suppressed audio information.

In Example 36, the machine-readable medium of any one or more of Examples 30-35, including instructions for optimizing reception by a far-end communication device, which when executed by a machine, optionally cause the machine to compress the noise suppressed audio information for transmission to the far-end communication device.

In Example 37, the machine-readable medium of any one or more of Examples 30-36, including instructions for optimizing reception by a far-end communication device, which when executed by a machine, optionally cause the machine to identify a machine context, and suppress feature noise in one or more feature bands of near-end generated audio information to provide feature-noise suppressed audio information.

In Example 38, the machine-readable medium of any one or more of Examples 30-37, including instructions for optimizing reception by a far-end communication device, which when executed by a machine, optionally cause the machine to compress the feature-noise suppressed audio information for transmission to the far-end communication device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method for processing audio received at a near-end device for optimized reception by a far-end communication device, the method comprising:
establishing a link with the far-end communication device using the near-end communication device;
identifying a context of the far-end communication device; and
selecting one audio processing mode of a plurality of audio processing modes at the near-end communication device, the one audio processing mode associated with the identified far-end context and configured to reduce reception error the audio by the far-end communication device.

2. The method of claim 1, wherein the identifying the context of the far-end communication device includes processing audio signals received from the far-end communication device.

3. The method of claim 1, wherein selecting one audio processing mode includes:
presenting an input mechanism for selecting the one audio processing mode at the near-end communication device; and
receiving an indication from the input mechanism associated with the one audio processing mode at a processor of the near-end communication device.

4. The method of claim 1, wherein the identifying the context includes receiving an in-audio-band data tone at the near-end communication device, and wherein the in-audio-band data tone includes identification information for the far-end context.

5. The method of claim 1, wherein identifying the context includes receiving an out-of-audio-band data signal at the near-end communication device, wherein the out-of-audio-band data signal is configured to identify the context of the far-end communication device.

6. The method of claim 1, wherein the establishing link with the far-end communication device includes establishing link with the far-end communication device over a wireless network using a near-end communication device.

7. The method of claim 1, wherein identifying a context includes identifying a human context; and
wherein the method includes suppressing noise in one or more frequency bands of near-end generated audio information to provide noise suppressed audio information.

8. The method of claim 7, including compressing the noise suppressed audio information for transmission to the far-end communication device.

9. The method of claim 1, wherein identifying a context includes identifying a machine context; and
wherein the method includes suppressing feature noise in one or more feature bands of near-end generated audio information to provide feature-noise suppressed audio information.

10. The method of claim 9, including compressing the feature-noise suppressed audio information for transmission to the far-end context.

11. An apparatus for audio communications with a far-end communication device, the apparatus comprising:
a microphone;
a processor configured to receive audio information from the microphone, to process the audio information according to one of a plurality of audio processing modes, and to provide processed audio information for communication to the far-end communication device; and
a context identification circuit to select an audio processing mode corresponding to an identified context of the far-end communication device from the plurality of audio processing modes of the audio processor.

12. The apparatus of claim 11, wherein the context identification circuit includes a selector configured to receive a manual input from a near-end user to select the audio processing mode corresponding to an identified context of the far-end communication device.

13. The apparatus of claim 11, wherein the context identification circuit is configured to receive communication information corresponding to a signal received from the far-end communication device, and to identify a context of the far-end communication device.

14. The apparatus of claim 13, wherein the communication information includes far-end sourced voice information; and
wherein the context identification circuit is configured to analyze the far-end sourced voice information to provide analysis information, and to identify a far-end context of the far-end communication device using the analysis information.

15. The apparatus of claim 13, wherein the communication information includes in-audio-band data information; and
wherein the context identification circuit is configured identify the context of the far-end communication device using the in-audio-band data information.

16. The apparatus of claim 13, wherein the communication information includes out-of-audio-band data information; and
wherein the context identification circuit is configured to identify the context of the far-end communication device using the out-of-audio-band data information.

17. The apparatus of claim 11, including a wireless transmitter configured to transmit the processed audio information to the far-end communication device using a wireless network.

18. The apparatus of claim 11, wherein the processor is configured to suppress noise of one or more frequency bands of the audio information to provide the processed audio information when the far-end context is identified as a human context.

19. The apparatus of claim 18, wherein the processor is configured to compress the processed audio information for transmission the far-end communication device.

20. The apparatus of claim 11, wherein the processor is configured to suppress feature noise of one or more feature bands of the audio information to provide the processed audio information when the far-end context is identified as a machine context.

21. The apparatus of claim 20, wherein the processor is configured to compress the processed audio information for transmission to the far-end communication device.

22. A machine-readable medium including instructions for optimizing audio reception by a far-end communication device, which when executed by a machine, cause the machine to:
establish a link with a far-end communication device using a near-end communication device;
identify a far-end context of the far-end communication device; and
select one audio processing mode of a plurality of audio processing modes at the near-end communication device, the one audio processing mode associated with the identified far-end context and configured to process audio received at the near-end for reduced reception error by the far-end communication device.

23. The machine-readable medium of claim 22 including instructions for optimizing reception by a far-end communication device, which when executed by a machine, cause the machine to process audio signals received from the far-end communication device.

24. The machine-readable medium of claim 22 including instructions for optimizing reception by a far-end communication device, which when executed by a machine, cause the machine to receive an indication from an input mechanism associated with the one audio processing mode at a processor of the near-end communication device.

25. The machine-readable medium of claim 22 including instructions for optimizing reception by a far-end communication device, which when executed by a machine, cause the machine to receive an in-audio-band data tone at the near-end communication device, wherein the in-audio-band data tone includes identification information for the far-end context.
